(19) United States
(12) Patent Application Publication
(10) Pub. No.: US 2008/0205662 A1
(43) Pub. Date: Aug. 28, 2008

(54) Vehicle sound (s) enhancing accessory and method

(76) Inventor: John Lloyd Matejczyk, Oakland, CA (US)

Correspondence Address: John H. Miller, 22465 E. Alder Dr., Aurora, CO, 80016, US

(21) Appl. No.: 11/710,159

(22) Filed: Feb. 23, 2007

(51) Int. Cl. G10K 11/16

(52) U.S. Cl. 381/71.4

(57) ABSTRACT

An audio system and method for enhancing sounds coming from the exhaust from an internal combustion engine of an operating vehicle, and optionally from other components of the vehicle including the engine compartment, into the passenger compartment of the vehicle, by using one or more microphones located close to one or more components and processing the signal(s) and sending them directly or indirectly to at least one speaker located in the passenger compartment or to at least one set of headphones is disclosed.

The invention is aimed at vehicle and driving enthusiasts and involves a system that enhances the various sounds of various parts of the vehicle during operation, a method of assembling the system and a method of using the system.

### BACKGROUND

Beginning about, or at least gaining popularity, in the early 1950's, driving enthusiasts, particularly younger driving enthusiasts, removed the factory muffler and installed “glass packs” or other aftermarket mufflers that enhanced the sound of the exhausts, particularly when accelerating from a stop or a low speed. Many didn't stop there, but went further to split the manifold(s) or to install headers to be able to install a second exhaust pipe, glass pack and tail pipe producing true dual exhaust, better known then as “a set of pipes”. Some of those sets of pipes had a very sweet sound, particularly to anyone who happened to be in the vicinity when the vehicle was accelerating, a sound that is rarely heard today. The closest thing to it heard today is a Harley Davidson®, but its sound is much harsher and louder. Nevertheless, one of Harley Davidson®'s selling features is it's exhaust sound.

Also, in the 1950's and 1960's it became popular to add sets of louvers to the hood, not only for looks, but also to allow the engine sounds to be better heard by the people in the vicinity, including the driver and passengers, particularly at high RPM's.

These sound enhancing features increased the sensual thrills and fun of driving, but usually sounded better to those outside the vehicle on the sidewalks, etc. than they did to the driver. Due to the Doppler effect and the interference of the passenger compartment, the driver never experienced the full potential of the enhanced sounds. This was before the time of air conditioners in the car and driving enthusiasts drove with the windows down even when the temperature didn't favor that, just to better experience the sounds of the pipes and the engine. Alas, now with air conditioning, terrible wind noise with the windows down and even better sound deadening in the passenger compartment, one can barely hear the engine and usually not the exhaust.

Many cars today appear to have dual exhaust, but most are not true dual exhausts, just two tailpipes coming from a common catalytic converter or muffler. Also, most mufflers do a good job of hiding the exhaust sound and do not give the enthusiasts what they want to hear. A few auto manufacturers have modified their mufflers to provide a deeper, throaty and louder sound, but still the normally closed and well insulated passenger compartment prevents the full excitement of the improvement. Maybe because the driver can no longer really enjoy his pipes, few bother to replace their factory mufflers with better sounding ones, and few such options exist today for that reason. Almost no one goes to the expense of adding louvers to the hood.

Convertibles and roadsters have enjoyed a real come-back in recent years, probably because the driver, and passenger, can better experience the thrill of the sounds of performance. But alas, even they loose some of the potential thrills to wind noise, Doppler effect, and rainy or cold weather. These are very old problems as most, maybe all, auto enthusiasts will agree. Many years ago a company named Ronco® marketed a product called Mr. Microphone® that contained a microphone and allowed a person or persons to broadcast on a predetermined FM frequency their voice(s) to the auto's FM radio when it was tuned to the same frequency, but while people had fun with this device, it did not solve or reduce the problems described above. Even today, Volkswagon® offers a device that permits an electric Guitar, etc. to be played through the auto's audio system, but this device also does not solve or reduce the problems described above.

Automakers are in a highly competitive performance environment. They have been steadily increasing the horsepower of their high-performance vehicles, hoping this will have a halo effect on the entire brand. For instance, Dodge advertises its “Hemi” engine. BMW features its “M” series. Nissan/Infiniti has added an additional exhaust sound to their sports models, with a sound-effect that is prominent in their advertising. These are just a few examples of many that try to differentiate via enhanced performance or the impression or reputation thereof.

### SUMMARY

In the current auto market, automakers need any edge that further establishes their performance credentials. This invention, an ability to truly listen to the sounds of the engine, exhaust, and possibly brakes and wind, will greatly enhance their customers' perception, and that of potential customers, in this ever-important area.

This invention will also allow sports drivers to have a natural sense of their car, improving their ability to drive in a high-performance fashion. Essentially, what's known as “road feel” will now have a better audio component to it. Imagine a driver being able to tune their car stereo to the sounds emanating from their car.

The present invention brings a solution to the old and new problems described above with a system that picks up vehicle operating sound or sounds that the driver and/or at least one passenger likes to hear and plays one or more of those sounds through a sound system in the passenger compartment of the vehicle while allowing the driver or passenger to select the sound or sounds to enhance, to control the sound level, and optionally to even blend two or more sounds for variety or personal preference.

The system comprises a vehicle, usually a vehicle having an internal combustion engine, at least one sound sensor and a device for feeding the signal(s) from the one or more sound sensors to a built-in audio system of the vehicle or to a separate audio system of various types in the vehicle. Optionally, the system can contain two or more sound sensors, two or more optional signal switches or a selector or a blending switch, an optional mixer, an amplifier and a device to feed the audio signal(s) from the amplifier to the audio system of the vehicle, to a separate audio system, or directly to one or more speakers. One type of separate audio system can include a set of headphones, including stereo headphones and/or a separate speaker or a set of regular or high fidelity speakers. The sound can also be fed to a recorder for listening to later. The term vehicle includes automobiles, SUV's, recreational vehicles, trucks of all kinds, busses, motorcycles, motor scooters, tractors, military vehicles and other similar vehicles.

One example of a system comprising two or more sound sensors includes one or more sound sensors close to an engine exhaust outlet, two sound sensors for a dual exhaust system, one or more sound sensors close to the engine, in the engine compartment, and one or more sound sensors close to a front wheel brake caliper and optionally one or more sound sensors close to one or both rear wheels. In this, or another embodiment, the amplified audio signals from the exhaust outlets can be fed to only rear speakers, i.e. speakers located behind the driver, along with optional audio signals from one or both rear wheels and an amplified signal from the engine, and optionally from one or both front wheels, can be fed to front speakers. The system of the invention can also comprise one or more mechanisms to move the sound sensor(s) physically when desired to enhance the sounds, e.g. the sound sensor(s) can be withdrawn to a protected or more esthetic position when not in use and then moved to a location where the sound is more desirable when in use. By locating a microphone close to a sound source, including an combustion gas exhaust outlet, is meant within about 5 feet, more typically within about 3 feet, even more typically within about two feet and most typically within about 1 foot of the sound source. By locating a microphone closer to the sound source is meant within less than about 1 foot, more typically within about 9 inches, even more typically within about 6 inches and most typically within about 4 inches.

Many modifications are possible and one modification is to feed the amplified signal from the left side exhaust to the left rear speaker and the amplified signal from the right side exhaust to the right side rear speaker. Additional modifications include feeding the amplified signal from near, or in, the engine to one front speaker and the amplified signal from in or near a front brake caliper to a different front speaker on the opposite side of the passenger compartment.

The invention also includes a method of enhancing performance sounds of a vehicle by mounting a sound sensor close to one or more engine exhaust openings of a vehicle, feeding the signal from at least one sound sensor to a mixer or a mixer-amplifier combination or to a amplifier that is part of the an existing stereo system in the vehicle (including an amplifier built into the speakers), and then to one or more speakers of a sound system in the vehicle, or to a separate sound system that can be, or include, a set of headphones. It is desirable if the sound system is a stereo system, but a mono system is also satisfactory.

A stereo system is particularly nice when two sensors are used and one sensor is near a first opening of the exhaust system and the other sound sensor is located near a second opening of the exhaust system of the vehicle, or near a location on the engine where the sound of the revolutions of the engine or air streaming into the air intake is particularly evident. When the vehicle has dual exhaust, a third sensor, and more sensors if desired, can be mounted at desired points near the exhaust outlets and near the engine. Also, a sensor can be mounted near one of the brake calipers to pick up the sounds of the brakes slowing the wheel.

Other sensors can be mounted at other locations in or on the vehicle to pick up other desired sounds, such as air passing over a surface that causes a desired sound, another part of the engine, etc. The method of operating the system comprises selecting the sound sensor signal(s) to feed to the amplifier, optionally positioning the sensors for a desired result, optionally mixing or selectively adjusting one or more signals to feed to the amplifier and adjusting the overall sound level in the audio system and optionally balancing the speakers to achieve the desired sound(s).

When using two or more sound sensors, optional switches can be used to listen to two or more signals coming from the sensors or any combination and/or an optional mixer, like that used to blend different sound frequencies in Hi-Fi systems or different musical instruments in a band, can be used by the driver or passenger to blend sounds coming from different sound sensors. Switches are not normally required when using a mixer because the mixer acts to vary the level of each signal including shutting it off completely.

As used herein, the term sound sensor means an item that picks up sound and converts it to a signal that when amplified and fed to a speaker, reproduces the sound sensed. The term includes all kinds of microphones and equivalents thereof.

This invention will be of great value to both carmakers, who may choose to build it into their cars, and to driving enthusiasts, who would buy cars equipped with the system or buy the system in aftermarket product(s). The system of the invention is especially desirable when driving where frequent stops, starts, and acceleration are being experienced, such as in commuting, and especially when touring on hilly, curvy, roads where braking and accelerating are being experienced and where on frequent occasions the engine can be revved to high RPM's.

When the word “about” is used herein it is meant that the amount or condition it modifies can vary some beyond that stated so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept, the objectives of the invention and embodiments disclosed, including the best mode known to the inventor, the inventor and others can, without inventive effort, explore beyond the limits disclosed using only ordinary skill to determine if the invention is realized beyond those limits, and when embodiments are found to be without any unexpected characteristics, those embodiments are within the meaning of term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF THE DRAWINGS

FIG. 1 is a partial plan view of a vehicle chassis showing an engine, an exhaust system and brake calipers and a portion of a system of the invention.

FIG. 2 is a schematic of another portion of the system of the invention.

FIG. 3 is a partial plan view of a vehicle chassis having an engine, real dual exhaust system, brake calipers and a portion of a preferred system of the invention.

FIG. 4 is a partial side view of a rear portion of a vehicle showing an optional feature for embodiments shown in FIGS. 1 and 3 embodiment of the invention.

### DETAILED DESCRIPTION OF SOME EMBODIMENTS OF THE INVENTION

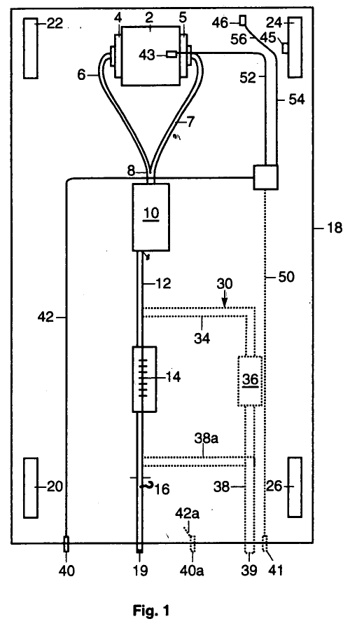

FIG. 1 is a partial plan view of a vehicle chassis containing an engine 2, having two exhaust manifolds 4,5, exhaust pipes 6,7 communicating with the exhaust manifolds 4,5 respectively and joining into a single exhaust pipe 8, an optional catalytic converter 10, a second exhaust pipe 12, a muffler 14, a tailpipe 16 and 4 brake calipers 20,22,24 and 26. A conventional chassis frame, and other conventional parts that are not part of the invention and holding and cooperating with the engine 2 and brake calipers 20-26 in the operation of the vehicle are not shown, but are well known. The general outline 18 of the body of the vehicle is not part of the invention and can vary tremendously as is well known.

The engine exhaust system-shown in FIG. 1 is a traditional exhaust system. As is known, when the engine is not a V-4, 6, 8, 10 or V-12 cylinder engine, the engine normally comprises only one exhaust manifold and one exhaust pipe leading to an optional catalytic converter, but normally required now on most vehicles, or to a muffler. The invention is also applicable to such inline, rotary or such other engines and exhaust systems.

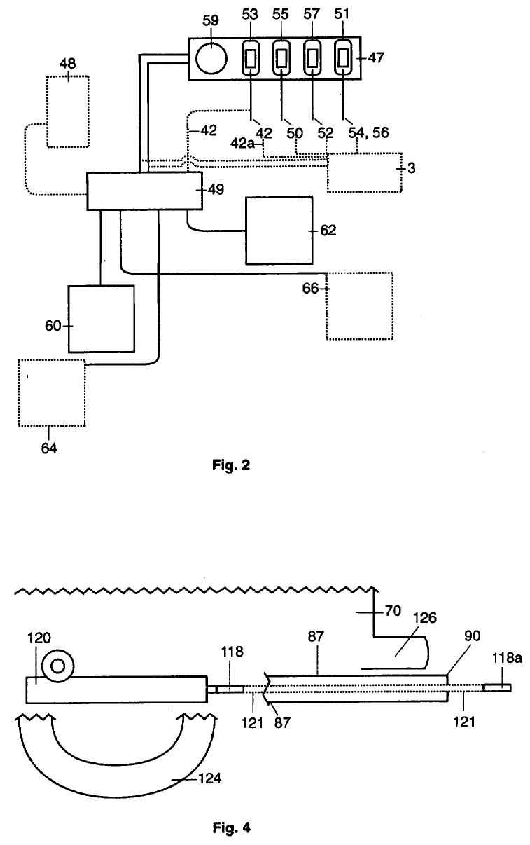

The system of the invention used on the vehicle of FIG. 1 comprises a sound sensor 40 or 40a mounted close to the exhaust outlet 19 and a device for sending a sound signal to an optional mixer 47 (FIG. 2) or an amplifier 49 that can be separate or a part of the conventional audio system in the vehicle or a separate audio system. The sound sensor 40 or 40a can be a microphone or any other device that will pick up sounds and send them in the form of a signal to one or more speakers or headphones or to an audio system that will send a modified signal to the speaker(s) or headphones.

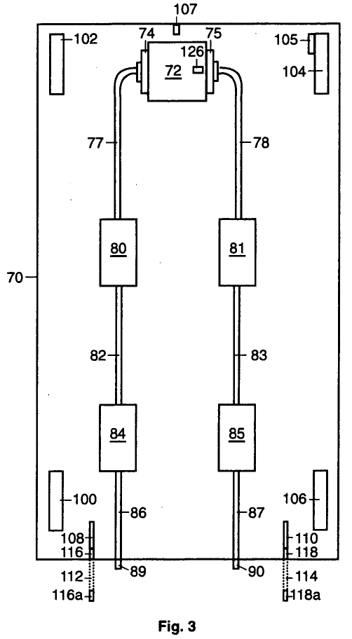

Also shown in FIG. 1 is an optional “so called” dual exhaust system 30 that technically ends in a second exhaust outlet 39, but lacks a second complete exhaust system from the engine 2 to the outlet 39,like the true dual exhaust system shown in FIG. 3. This “so called” dual exhaust system 30 can comprise either a second exhaust pipe 34, an optional second muffler 36 and a second tail pipe 38 ending in a second exhaust outlet 39, or alternatively only a second tailpipe 38a, ending in the second exhaust outlet 39. In these embodiments, a sound sensor 40 is mounted to be located near the first exhaust outlet 19, that can be on either side of the exhaust outlet 19 including in the center of the back of the vehicle as shown as 40a. In the embodiment having a second exhaust outlet 39, a second sound sensor 40a or 41 can be located close to that exhaust outlet 39, or a single sound sensor 40 or 40a can serve to pick up the sound for both exhaust outlets 19 and 39. For best results, the sound sensor 40, 40a and/or 41 should be near the exhaust outlet 19 or outlets 19 and 39, below, above or on the same level and most desirably, but not necessarily, extending beyond the exhaust outlet(s) 19, and 39 to eliminate any Doppler effects.

In the embodiments shown in FIG. 1, another sound sensor 43 can be mounted to be in a position to detect the sound of the engine 2 and also, if desired, another sound sensor 45 can be mounted close to one of the brake calipers 24,26,22,20. If desired, another sound sensor 46, mounted to catch the sound of air rushing into or past the vehicle, such as in or near the front of the vehicle, can be used.

Any sound sensor suitable for use in harsh or outside conditions and meeting the descriptions below can be used in the present invention. Any microphone, sound sensor, suitable for the environment and having the capability of capturing a frequency range of at least about 100-10,000 Hz, more typically about 50-15,000 Hz and most typically from about 20 Hz or lower to at least about 20,000 Hz is suitable for use in the invention. The microphone or other type of sound sensor should be able to withstand water, salt water normally found on streets after a snow or ice storm and to withstand temperatures from at least about −20 degrees F. to about 130 degrees F., or higher for the microphone placed near the engine.

Some microphones suitable for use in the present invention include the HLSC 1, HLSC—2 HighLine™, HLSC—3 Croakie™, Combo 4 and MM-BSM-9 available from Microphone Madness™ Of Palm Coast, Fla., Solo® Executive System available from Revolabs™, Inc. of Maynard, Mass., Long Ranger™ III with M119 Lavalier™ microphones available from Lectronics™, Inc., Sennhieser™'s MKH 418S, Sony's ECM 719, Shure Pro Audio™'s SM 63, and Professional Sounds Corporation's SGM 1, to name a few. The microphones can be wireless or connected to the system with transmission wires. Various voltages can be used with the microphones, but 12 volt is favored because of the ease and cost of using the vehicle's 12 volt system as the power source. It is desirable to mount the microphone(s) for picking up the exhaust sound from one or two exhaust outlets on the end portion of a power radio antenna so that the microphone(s) can be located at a near optimum location for picking up the exhaust sound when the system of the invention is in use, but withdrawn to a safe, non-obtrusive location under the vehicle when the system of the invention is not in use. Any power antenna can be used including a Pyramid EA 48 available from Ace Photo and Digital™ (acephotodigital.com/index.asp) and a Legacy™ LN 46 Fully Automatic Power Antenna available from ST Great Deals (sjgreatdeals.com).

FIG. 2 shows a schematic of another portion of the audio system for use with, or of the invention. The sound signal from each of the sound sensors used can be transmitted to an optional mixer 47 with either wires 42, 42a, 50, 52, 54, 56, or transmitted as a remote signal to the mixer 47 in a known manner, such as by using a Long Rangers III or IV system available from Lectrosonics™, Inc. of Rio Rancho, N. Mex., a Fender Passport Deluxe™ PD 250 system available from the Fender Musical Instruments Company of Corona, Calif. The mixer 47 is a 4 channel mixer with signal adjusters 51,53,55 and 57 that can be moved to adjust the signal level of each of the microphone inputs to produce an output signal having the desired mix according to the person(s) listening. An optional volume control 59 on the mixer can control the level of the signal going to the rest of the system. Another option is for one or more of the microphone wires 42, 42a, 50, 52, 54, or 56, or the output from the mixer 47 can be fed to a Mr. Microphone®, or an equivalent FM modulator or FM transmitter, that will broadcast on an FM frequency that the vehicle FM radio can pick up and produce the audio sound(s) through the vehicle's speakers, or optionally can be picked up on a portable FM radio and played through the portable's speakers.

If only one sound sensor is used in the system, the sound signal can be transmitted directly to an amplifier 49 that drives one or more speakers in the vehicle, either the optional speaker(s) 60,62, the optional speakers 64,66 that are part of a built-in radio/cassette/CD system 48 of the vehicle or to one or more separate speakers (not shown). The separate speakers in any of the embodiments can be one or more portable speakers located in the vehicle, one or more sets of headphones, one or more speakers located in the one or more of the headrests, in the top portion of the driver's seat, on the back floorboard or in other conventional locations. It is sometimes desirable to have a system of the invention separated from the vehicle's built-in audio system 48 so that music or other broadcast programs can be heard in addition to the desired vehicle sounds.

As shown in FIG. 2, when two or more sound signals are being picked up, those signals can be fed to the mixer 47 where the level of each signal can be adjusted by the driver or passenger to provide the desired sound effect and the resultant mixed signal then fed to the amplifier 49 with one or two wires 130 and then on to either the built in vehicle audio system 48, or to separate speakers or headphones 60,62, etc. The level of the sound and balance between the speakers can be adjusted either on the amplifier 49 or the built-in audio system 48 in the vehicle. Of course, the optional mixer 47 and amplifier 49 can also be built in or integrated into the built-in audio system 48 in the vehicle. Any reasonable type of mixer is suitable for use in the system of the invention and 12 or 9 volt mixers particularly suitable are the RMS 4-Channel Personal Stereo Mixers and the RMS 4 Channel Micro Mixer™ RMM 290 available from Get-It-All.net. Using components that use a 12 volt power supply are advantageous because they can be run by the vehicle's 12 volt electrical supply system. Many more mixers are available that require 120 volt power supply and these can be used by including in the system a 12 volt to 120 volt inverter which are readily available. One of many such inverters that are suitable is the Monster Cable™ MCPI-150 Mobile Power Station available from ShopTronics.com. This inverter delivers 150 watts of power and higher power output inverters can be used if desired. One of many suitable 120 volt mixers suitable for use in the system of the invention is the Sampson™ MDR 1064 Compact Mixer available from Sampson Technologies Corporation of Hauppauge, N.Y.

A most typical embodiment is shown in FIGS. 3 and 4. The engine exhaust system of this embodiment is a true dual exhaust system. FIG. 3 is a partial plan view of a vehicle chassis 70 containing an engine 72, having two exhaust manifolds 74,75, exhaust pipes 77,78 communicating with the exhaust manifolds 74,75 respectively and feeding two optional, but normally required by law,-catalytic converters 80 and 81. Second exhaust pipes 82 and 83 transport exhaust gases from the catalytic converters 80,81 to mufflers 84 and 85 respectively. The mufflers 84 and 85 can be of any type including gutted, tuned or glass-pack mufflers. Final tailpipes 86 and 87 direct the exhaust from the mufflers 84 and 85 respectively to exhaust outlets 89 and 90 that can be the end of the final tailpipes 86 and 87 or ornamental exhaust tips or extensions (not shown, but well known).

The chassis also includes brake calipers 100,102,104 and 106. A conventional frame, and other parts, not part of the system of the invention, holding and cooperating with the exhaust system, engine 2 and brake calipers 100-106 in the operation of the vehicle are not shown, but are well known. The general outline 70 of the body of the vehicle is not part of the invention and can vary tremendously as is well known.

The embodiment of the system of the invention shown in FIG. 3 comprises sound sensors 116 and 118, usually, but not necessarily, mounted under the vehicle when not in use, but movable to be close to the exhaust outlets 89 and 90, see 116a and 118a, when the system of the invention is turned on. Any reasonable mechanism for moving a microphone can be used in this embodiment, but shown in FIG. 4 is an automatic motorized antenna mechanism 120, antenna 121 and the wireless microphone 118,118a in the home and working positions respectively, the latter in a desirable position with respect to the exhaust outlet 90 to capture the rich sound of the exhaust. Any reasonable motorized antenna type device or equivalent can be used in this embodiment to move the microphones, including a Pyramid™ EA 48, available from acephotodigital.com/index.asp, and a Legacy™ LN 46, available from stgreatdeals.com. Wired microphones can be used in this embodiment too, but a wireless device is preferred. The motorized antenna(s) 120 and microphone(s) 116 and/or 118 can be mounted in a protected area, such as between the back wheels 124 and below the body pan (not shown) beneath the back seat, and then the microphones 116,118 are moved out beneath or near the rear bumper 126 to operating positions 116a,118a when the system of the invention is turned on, or, alternately when a separate switch for the antenna is turned on. This system could also be located in or below the trunk of the vehicle to move the microphone(s) 116 and/or 118 into position above or through the bumper 126. Optionally, only one microphone 116 or 118 can be used instead of both in FIG. 3, usually mounted to extend to a position to pick up the exhaust sounds, most desirably at or near the lengthwise centerline of the vehicle.

Like the embodiments shown in FIG. 1, this embodiment of FIG. 3 has one or more sound sensor(s) 126 mounted close to the engine 72 and also, if desired, another sound sensor 105 can be mounted close to one of the brake calipers 100, 102, 104, 106, in this embodiment in a protected location close to the inboard side of brake caliper 104. If desired, another sound sensor 107 is mounted to catch the sound of air rushing into or past the body, such as in or near the front of the vehicle. Any sound sensor suitable for use in harsh or outside conditions can be used in the present invention, but in the embodiment shown in FIG. 3, the sound sensors are wireless microphones. The systems shown in FIG. 2 are used with this embodiment, particularly the system containing a mixer 47 having at least 5 channels.

Several embodiments of the invention have been shown in detail above, but, given the disclosure above, there are many obvious variations of these embodiments. The many embodiments disclosed above and these obvious variations of the embodiments disclosed are meant to be included in the following claims literally or by the doctrine of equivalents.

1. An audio system for enhancing sound(s) of a vehicle, the vehicle having an internal combustion engine communicating with the at least one exhaust outlet, the engine located in an engine compartment, the sound(s) including that of the combustion gases exiting at least one exhaust outlet of the vehicle, the audio system comprising at least one microphone located close to the at least one exhaust outlet or in the engine compartment, a device for receiving one or more signals directly or indirectly from one or more microphones and for preparing and sending an audio signal to an audio system, at least one speaker and/or at least one set of headphones and/or to at least one portable speaker in the vehicle, or to a combination of speakers and/or headphones.

2. The audio system of claim 1 further comprising a mixer for receiving signals from at least two microphones and sending a blend of at least two signals.

3. The audio system of claim 1 further comprising an FM modulator capable of broadcasting an audio signal on an FM frequency that an FM radio can receive.

4. The audio system of claim 2 in which the signal from the mixer is sent to an FM modulator capable of broadcasting an audio signal on an FM frequency that an FM radio can receive.

5. The audio system of claim 1 further comprising an amplifier for preparing the audio signal for the at least one speaker.

6. The audio system of claim 2 further comprising an amplifier for preparing the audio signal for the at least one speaker.

7. The audio system of claim 2 wherein the audio system comprises at least one microphone located close to an exhaust outlet and at least one microphone located in the engine compartment.

8. The audio system of claim 2 wherein signals from two or more microphones are fed to the mixer.

9. The audio system of claim 3 wherein signals from two or more microphones are fed to the mixer.

10. The audio system of claim 4 wherein signals from two or more microphones are fed to the mixer.

11. The audio system of claim 5 wherein signals from two or more microphones are fed to the mixer.

12. The audio system of claim 6 wherein signals from two or more microphones are fed to the mixer.

13. The audio system of claim 7 wherein signals from three or more microphones are fed to the mixer.

14. The audio system of claim 8 wherein at least one of the microphones is located in the engine compartment of the vehicle.

15. The audio system of claim 9 wherein at least one of the microphones is located in the engine compartment of the vehicle.

16. The audio system of claim 10 wherein at least one of the microphones is located in the engine compartment of the vehicle.

17. The audio system of claim 11 wherein at least one of the microphones is located in the engine compartment of the vehicle.

18. The audio system of claim 12 wherein at least one of the microphones is located in the engine compartment of the vehicle.

19. The audio system of claim 13 wherein at least one of the microphones is located in the engine compartment of the vehicle.

20. The audio system of claim 1 wherein the system includes one or more devices for moving the one or more microphones from a more protected location to a location closer to the at least one exhaust outlet.

22. The audio system of claim 2 wherein the system includes one or more devices for moving the one or more microphones from a more protected location to a location closer to the at least one exhaust outlet.

23. A method of enhancing the sound(s) of the combustion gases exiting at least one exhaust outlet of a vehicle, the vehicle having an internal combustion engine communicating with the at least one exhaust outlet, the engine located in an engine compartment, comprising locating at least one microphone close to the at least one exhaust outlet or in the engine compartment and sending a signal from the microphone(s) to directly or indirectly to a device for receiving one or more signals directly or indirectly from the microphone(s) and preparing sending an audio signal to an audio system, at least one speaker and/or at least one set of headphones and/or to at least one portable speaker in the vehicle, or to a combination of speakers and/or headphones.
